(19) United States
(12) Patent Application Publication
(10) Pub. No.: US 2018/0261091 A1
(43) Pub. Date: Sep. 13, 2018

(54) HOME AND WORK NAVIGATION INFORMATION IN MAIN RADIO DISPLAY WITH IMMEDIATE NAVIGATION ACCESS

(71) Applicant: Cesar Hernandez-Urbina, Birmingham, MI (US)

(72) Inventor: Cesar Hernandez-Urbina, Birmingham, MI (US)

(21) Appl. No.: 15/452,800

(22) Filed: Mar. 8, 2017

(51) Int. Cl. G08G 1/133

(52) U.S. Cl. CPC G08G 1/133

(57) ABSTRACT

A system and method is used with a vehicle to provide updated real time information to an operator concerning a selected location. The system may have a processor, a non-volatile memory, an interface and a display system in communication with one another. The interface may provide a location selection control for a vehicle operator to input, save and thereafter select a programmed location. The processor may use the programmed location to determine and display an estimated time of arrival (ETA) to the location on the display system. The ETA may be saved if the vehicle is powered down, and then made available again to the processor again when the vehicle is re-started. Optionally, a distance associated with the programmed location may also be determined and presented to the user on the display. The distance is also saved if the vehicle is powered down.

### FIELD

The present disclosure relates to infotainment systems used in cars and trucks, and more particularly to an infotainment system having the capability to display continuously updated distance and estimated time of arrival (ETA) information relative to a specific, vehicle operator selected location or locations.

### BACKGROUND

The statements in this section merely provide background information related to the present disclosure and may not constitute prior art.

Vehicle infotainment systems are presently being leveraged to incorporate more features to enhance the vehicle operator's driving experience and to make more useful information available to the operator. However, such systems do not provide real time, continuously updated information concerning travel time and distance to user selected locations. Such information would be highly useful to most operators, particularly so if additional traffic and weather related information is leveraged to provide intelligent estimates on distances and estimated arrival times to user programmed locations.

### SUMMARY

In one aspect the present disclosure relates to a system for use with a vehicle to provide updated real time information to a user concerning a selected location. The system may comprise a processor, a non-volatile memory in communication with the processor, and a display system in communication with the processor. An interface may be included which is in communication with the processor. The interface may provide a location selection control by which a vehicle operator is able to input, save and thereafter select a location. The processor may be configured to use the location to determine an estimated time of arrival (ETA) to the location and to display information pertaining to the ETA to the operator on the display system. The ETA may be saved if the vehicle is powered down, and made available to the processor again when the vehicle is re-started for operators to know as soon as they get into the vehicle how far in terms of at least one of time or distance they are away from the selected location without the need to manually instruct the vehicle's navigation system to determine this information.

In another aspect the present disclosure relates to a method for use with a vehicle to provide updated real time information to a vehicle operator concerning a selected location The method may comprise using a processor associated with a system of the vehicle to communicate with a non-volatile memory, and using a display system to communicate with the processor and to display at least one of a distance and an estimated time of arrival (ETA) to the operator. The method may also involve using an interface to communicate with the processor, the interface enabling a location to be programmed into the memory by the operator, and thereafter selected by the operator using a location selection control associated with the interface. The method may further involve using the processor to determine the estimated time of arrival (ETA) and/or distance to the programmed location, and to display the ETA/distance to the operator on the display system. The method may further involve saving the ETA in the memory when the vehicle is powered down, and making the ETA available to the processor and to the display again when the vehicle is re-started. The method does not require that navigation instructions (voice or image instructions) to the operator selected location, or locations, be provided to the operator unless requested by the user.

### BRIEF DESCRIPTION OF THE DRAWINGS

The drawings described herein are for illustration purposes only and are not intended to limit the scope of the present disclosure in any way.

FIG. 1 is high level diagram illustrating one example of a system in accordance with the present disclosure; and

FIG. 2 is a flowchart illustrating operations that the system of FIG. 1 may perform.

### DETAILED DESCRIPTION

The following description is merely exemplary in nature and is not intended to limit the present disclosure, application, or uses. It should be understood that throughout the drawings, corresponding reference numerals indicate like or corresponding parts and features.

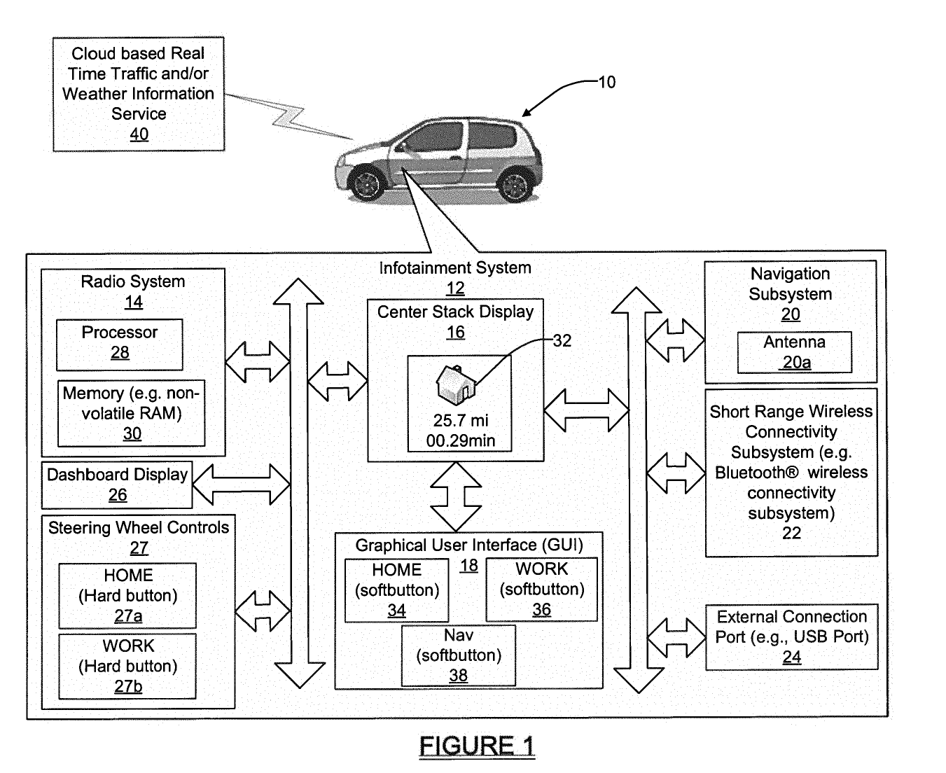

Referring to FIG. 1, a motor vehicle 10 is shown having an infotainment system 12 in accordance with one example of the present disclosure. The vehicle 10 is shown as a car, although it will be appreciated that the infotainment system 12 is not limited to use with only cars, but is expected to find utility in other forms of motor vehicles such as, without limitation, SUVs, pickup trucks, minivans, full size vans, etc.

The infotainment system 12 (hereinafter simply “system 12”) may include a radio system 14, a center stack display 16, a graphical user interface 18 (hereinafter simply “GUI 18”) that is separate from, or incorporated into, the center stack display 16, a navigation subsystem 20 operably associated with an antenna 20a, a short range wireless connectivity subsystem 22 (e.g., a Bluetooth® wireless connectivity subsystem) and an external connection port 24 for physically coupling an external device such as a smartphone, laptop, or any other form of personal digital assistant (“PDA”). Optionally, the system 12 may include a dashboard display 26. Optionally, the system 12 may include steering wheel controls 27 in which a dedicated “HOME” hard button 27a and a dedicated “WORK” hard button 27b may be located on a steering wheel of the vehicle 10.

The radio system 14 may incorporate one or more of a processor 28, a non-volatile memory 30 (e.g., non-volatile random access memory (RAM) or read only memory (ROM)) for storing user input information or information received from external (e.g., cloud-based) information sources, or any other information available to the processor 28. The center stack display 16 may also optionally include an icon 32 of the user's home and/or work, along with real time, continuously updated information on the vehicle's 10 present distance from the user's home or work, as well as the real time estimated time of arrival (“ETA”) and/or distance from the vehicle's current location to the user's home or work. Whether the distance and ETA to the user's home or work is displayed may depend on which location the user has programmed into the system 12. User programming may be accomplished through a “HOME” selection control 34 and a “WORK” selection control 36 incorporated into the GUI 18. The HOME and WORK Selection controls 34 and 36 may be “soft buttons” available through touch controls if the GUI 18 is incorporated into the center stack display 16. Optionally, the HOME and WORK selection controls 34 and 36 may be controls mounted near the location of the center stack display 16, or at a different location on the vehicle's dashboard, or as hard buttons 27a and 27b on the vehicle's steering wheel, or possibly even in an overhead location such as on an overhead console. Accordingly, the HOME and WORK selection controls 34 and 36 may be located at virtually any location within the vehicle 10 that is convenient for the vehicle operator to access. These two display controls HOME 34 and WORK 36 may themselves also form dedicated “NAV” buttons to immediately start a navigation process (voice and image instructions) to the selected location (i.e., either to the programmed “HOME” or “WORK” locations that the operator has input). The operator's home and work locations may be stored in the memory 30 or in any other memory that is accessible and usable by the system 12. The operator may have the option to de-select automatic voice and map directions for the HOME and WORK selection controls 34 and 36, so that when either of these selections is selected only time and/or distance information is shown to the user.

While the HOME and WORK selection controls 34 and 36 have been described as pertaining to the operator's home and work addresses, and enable the operator to use the GUI 18 to program in her/his home address and work addresses to the system 12, the system 12 may optionally include more than two selection controls 34 and 36 to allow the operator to program in more than two important addresses. Still further, the system 12 may optionally enable only one selection control (i.e., either selection control 34 or 36), which the user can designate as “HOME” or “WORK”. Still further, the system 12 may be modified to enable the user to designate and program either of the selection controls 34 or 36, or just one, with any designation she/he wishes (e.g., “Mom's home”, “Vacation home”, “Client XYZ”, “Grandma”, “Office”, “Plant”, hospital, doctor's office, etc.). Accordingly, the HOME and WORK selection controls 34 and 36 enable a wide degree of flexibility for the operator to configure the system 12 in a manner that best meets her/his needs.

The short range wireless connectivity system 22 may work in a well known manner to automatically establish a wireless connection with the user's PDA (e.g., smartphone, laptop, etc.) if the PDA is powered on and being carried by the operator when the operator enters the vehicle 10. The external connection port 24 may enable a hard wired connection to be made to the user's PDA, which may enable one or more applications on the operator's PDA to be presented on the center stack display 16 and/or utilized by the system 12, and/or other stored information (e.g., contacts, music, etc.) to be used by the system 12. The external connection port 24 may also enable charging of the PDA.

The system 12 may also optionally make use of a remote, for example cloud-based, real time traffic and/or weather information service 40 (hereinafter “service 40”). Service 40 may be accessed using the user's PDA, assuming the PDA is powered on and has made a connection with the system 12 through either the wireless connection subsystem 22 or the external connection port 22. Optionally, if the system 12 of the vehicle 10 includes a 3G or 4G modem, then accessing the service 40 will not require the use of the user's PDA smartphone; instead the service 40 may be accessed directly by the system 12.

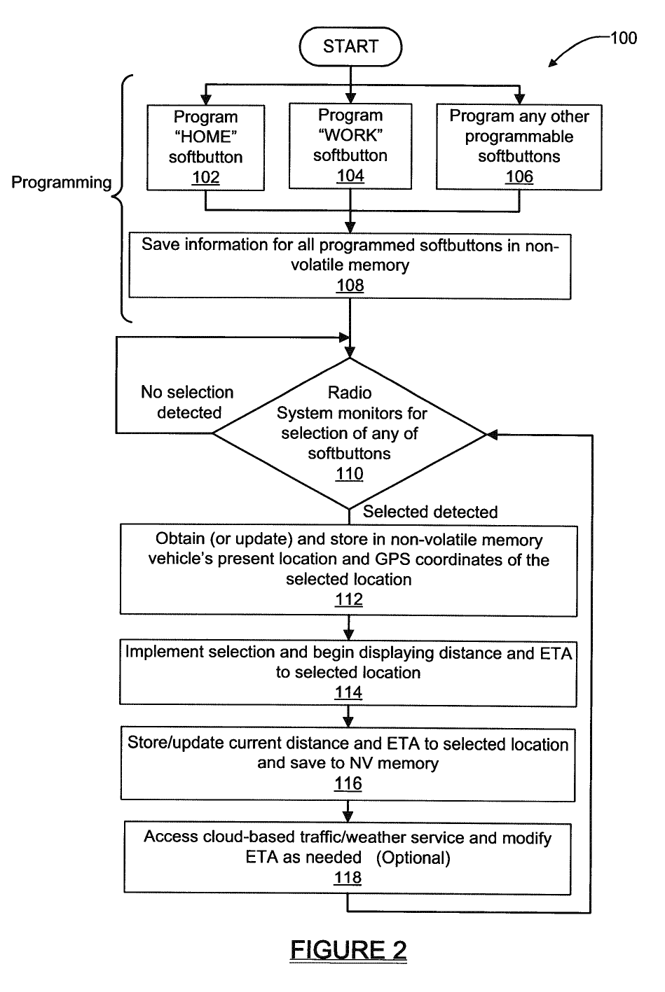

Referring to FIG. 2, a flowchart 100 is shown of various operations that may be performed in using the system 12. Initially at operations 100-106, the HOME soft button 34, the WORK soft button 36 and any other soft buttons available for programming by the vehicle operator may be programmed. This may involve the operator simply pressing on the selected soft button and holding for one or more seconds to initiate a programming mode. An indication may be provided by the system 12, for example the selected soft button may flash one or more times to confirm to the user that the programming mode has been entered. The system 12 may then present a soft keyboard on the center stack display 16 by which the operator may enter an address (e.g., home, work or other location) that the operator wishes to program. At this point the entered information will be saved in the memory 30, which as noted above may be a non-volatile memory. This is highly beneficial because with a non-volatile memory such as memory 30, the system 12 is able to retrieve the last known location of the vehicle 10, the last known distance to the selected location, and the last estimated ETA to the selected location, even if the vehicle ignition is turned off. In that instance, when the operator re-enters the vehicle 10 and starts the vehicle, the system 12 “remembers” the location of the vehicle as well as the last calculated distance to the selected location and the last calculated ETA at the selected location. There is no need for the user to manually access the navigation system and restart a navigation operation, or to re-select the previously selected location, when the vehicle is started. This adds significant convenience for the user when periodic stops need to be made on the way to the selected location, where the vehicle 10 ignition is repeatedly turned on and off.

At operation 110 the processor 28 of the radio system 14 may begin monitoring for the selection of one or the other of the soft buttons 34 or 36 (or any additional soft buttons) that have been programmed by the operator. If no selection has been detected, then operation 110 may be repeated. When a selection is detected at operation 110, then the processor 28 may command the navigation subsystem 20 to obtain the vehicle's current location and the GPS coordinates of the location that has been selected, as indicated at operation 112. By using the obtained real time location of the vehicle 10, as well as the GPS coordinates of the selected location, the processor 28 may calculate a distance to the selected location as well as an estimated time of arrival (ETA), and may begin displaying the distance and ETA on the center stack display 16, the dashboard display 26 or any other display, as indicated at operation 114. Optionally, the distance and ETA could even be displayed on a display of the operator's PDA (e.g., smartphone, tablet, etc.), assuming that a connection (wireless or wired) has been made with the operator's PDA. An additional PDA feature (e.g., application running on the PDA and synched to the system 12) may include an interface on the PDA for the operator to share her/his ETA through a text message, mail or automated voicemail to a contact within their device, app, other. In this example the ETA would be uploaded by the system 12 via the short range wireless communications link with the PDA, to the operator's PDA, by the operator selecting a control displayed on her/his PDA, or alternatively possibly from a control displayed on the center stack display 16 or the dashboard display 26. The entire operation could be controlled using only the system 12, or controlled in part by the application running on the operator's PDA.

At operation 116 the system 12 may store or update the calculated distance and ETA information to the non-volatile memory 30. At operation 118, the system 12 may optionally access the cloud-based weather/traffic service 40 to modify its calculations of distance and ETA based on real time traffic reports, road closures, weather conditions affecting traffic movement, etc. Still further, the system 12 may optionally recommend an alternate route to the operator if a traffic disruption is present along the shortest or most direct route to the user's selected location. Operations 110-118 may be repeated to continuously update the displayed distance and ETA information being provided to the operator.

The system 12 thus provides a system and method for continuously determining, in real time, a location of the vehicle 10, a distance to a user selected location (home, work or other location), as well as an ETA to the user's selected location. It is a principal benefit that the system 12 stores the determined distance and ETA information in non-volatile memory 30 when the vehicle ignition is turned off so the determined information is not lost. This provides an extremely intelligent system and method for being able to continuously apprise the operator of her/his distance from a selected location as well as to provide an estimated ETA. In this manner, even if the vehicle operator makes a temporary stop at a gas station, convenience store, etc., when the operator the re-enters the vehicle, the information pertaining to the selected location (i.e., distance and ETA information) will be immediately displayed to the operator on the system 12. The user is not required to re-enter a location selection or perform any other keystroke sequence. Thus, the system 12 eliminates the need of the operator to directly access the navigation subsystem 20 and perform one or more keystroke selections every time the vehicle ignition is turned off in an attempt to acquire the desired distance information. And even present day navigation systems typically do not present estimated time of arrival information to a selected location. Providing the operator with dedicated HOME and WORK soft buttons 34 and 36, respectively, thus significantly enhances the convenience for the operator in using the vehicle 10.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

1. A system forming an integrated infotainment system of a vehicle to provide updated real time information to an operator concerning a selected location, the system comprising:
a processor integrated into the infotainment system;
a non-volatile memory integrated into the infotainment system and in communication with the processor;
a display integrated into the infotainment system and in communication with the processor;
an interface integrated into the infotainment system and in communication with the processor, the interface providing a location selection control by which a vehicle operator is able to input, save and thereafter select a location;
the processor configured to use the location to determine an estimated time of arrival (ETA) to the location, and to display information pertaining to the ETA to the operator on the display system; and
wherein the ETA is saved if the vehicle is powered down, and made available to the processor again when the vehicle is re-started without requiring the operator to re-select the location after re-starting the vehicle.

2. The system of claim 1, wherein the interface further comprises an additional location selection control by which the operator is able to enter, save and thereafter select the additional location.

3. The system of claim 1, wherein the interface forms a graphical user interface.

4. The system of claim 1, wherein the location selection control is a soft button accessible by the operator on the interface.

5. The system of claim 2, wherein the location selection control and the additional location selection control each comprise soft buttons accessible by the operator on the interface.

6. The system of claim 1, wherein the ETA is updated by the processor using a remote information source that provides at least one of traffic and weather information.

7. The system of claim 1, further comprising a dedicated navigation selection button enabling the operator to implement a navigation operation to the location associated with the location selection control.

8. The system of claim 7, wherein the navigation selection button is a soft button accessible through the interface.

9. The system of claim 1, further comprising a dashboard display in communication with the processor.

10. The system of claim 1, wherein the processor and the memory form a portion of a radio system.

11. The system of claim 1, further comprising a navigation subsystem.

12. The system of claim 1, further comprising a short range wireless connection system for enabling a wireless connection to be made between a personal digital assistant (PDA) and the processor of the system.

13. The system of claim 1, wherein the display comprises a center stack display and includes a dedicated icon that is displayed when the user has made a selection via the location selection control.

14. The system of claim 13, wherein both a distance to, and the ETA to, the location are displayed adjacent to the icon.

15. A method for using a vehicle infotainment system of a vehicle to provide updated real time information to a vehicle operator user concerning a selected location, the method comprising:
using a processor associated with the vehicle infotainment system to communicate with a non-volatile memory of the vehicle's infotainment system;
using a display system of the vehicle infotainment system to communicate with the processor and to display at least one of a distance and an estimated time of arrival (ETA) to the operator;
using an interface associated with the vehicle infotainment system to communicate with the processor, the interface enabling a location to be programmed into the memory by the operator, and thereafter selected by the operator using a location selection control associated with the interface;
using the processor to determine the estimated time of arrival (ETA) to the programmed location, and to display the ETA to the operator on the display system; and
wherein the ETA is saved in the memory when the vehicle is powered down, and made available to the processor and to the display again when the vehicle is re-started without requiring the user to re-select the location after re-starting the vehicle.

16. The method of claim 15, wherein the ETA is continuously updated by the processor and displayed on the display system.

17. The method of claim 15, wherein using an interface to enable a location to be programmed into the memory comprises using a soft button displayed on a graphical user interface to enable the location to be programmed into the memory.

18. The method of claim 15, wherein the processor further determines a distance to the programmed location and the display system displays the determined distance along with the ETA.

19. The method of claim 15, further comprising using a navigation button operably associated with the interface to enable the operator to immediately select a navigation operation corresponding to the programmed location.

20. The method of claim 15, wherein:
the location selection control is a dedicated soft button presented on the interface;
the interface is a graphical user interface operably associated with the display system; and
further comprising an additional selection control formed by an additional dedicated soft button, the additional selection control enabling the operator to program an additional location into the memory and to thereafter select the additional location by accessing the additional dedicated soft button.
